(19) United States
(12) Patent Application Publication
(10) Pub. No.: US 2010/0119296 A1
(43) Pub. Date: May 13, 2010

(54) Movable armature and methods for creating a sculpture

(76) Inventor: Jeffrey Payne Lara, Navasota, TX (US)

Correspondence Address: THE MATTHEWS FIRM, 2000 BERING DRIVE, SUITE 700, HOUSTON, TX, 77057, US

(21) Appl. No.: 12/291,403

(22) Filed: Nov. 11, 2008

(51) Int. Cl. F16C 11/06

(52) U.S. Cl. 403/24

(57) ABSTRACT

A movable armature for creating a sculpture and related methods of use are described herein. The armature includes a plurality of rigid members, each having a shape representing part of an object to be sculpted. Each rigid member is pre-formed to be proportional in size to each other rigid member. One or more movable members are usable to connect adjacent rigid members, thereby providing a range of motion between two connected rigid members. The movable armature thereby eliminates mistakes relating to proportionality, while enabling continuous positioning and repositioning of the armature throughout the sculpting process.

### FIELD

The present embodiments relate, generally, to a movable armature and methods for creating a sculpture.

### BACKGROUND

Conventionally, when creating a sculpture, a frame or base, called an armature, must first be constructed, to support the many layers of foam, clay, metal, and/or other materials that will be manipulated by the sculptor. A unique armature is typically custom built for every sculpture, and includes a metal or wire frame having a desired shape.

If the sculpture is small, perhaps 18-24 inches in length, a first layer of clay is added directly to the frame to form a rough base shape of an object, such as a skeletal system of an animal. A second layer of clay is then placed over the first layer and is shaped to add texture and detail, such as musculature and facial features.

For larger sculptures, a foam filler, typically polystyrene, is normally used to reduce the weight of the finished product, add volume, and conserve expenses relating to clay costs. Foam is first attached to the frame, then the foam is cut or otherwise shaped to form the rough shape of the sculpture, on which a layer of clay is placed and sculpted to add the detailed features of the sculpture.

The creation of a customized armature for a sculpture is a difficult and time-consuming task, often requiring years of professional study and training to produce an armature having parts that are proportional in relation to one another. Any mistakes in the proportionality of a shape or pose of the armature, especially when sculpting a human or other animal, are critical and will be noticeable in the finished sculpture.

A conventional armature is normally stationary once constructed, and is unable to be reshaped, moved, or repositioned to correct any mistakes relating to proportionality, or other mistakes. To modify an armature and/or correct a mistake in a clay sculpture, an appropriate location must be determined at which the clay sculpture can be cut, such as a joint area in a sculpture of a human, to permit access to the armature. The metal or wire frame of the armature must then be re-shaped or bent, such as by heating the metal while manually pushing or pulling a part of the sculpture. Clay must then be reapplied over the affected areas and re-sculpted.

Once a sculpture is completed, it must often be separated into pieces for transport or for forming a mold for bronze or another metal, which can be reassembled at its final destination. Therefore, even when no mistakes relating to the armature, or other mistakes, are made during the creation of a sculpture, it may still be necessary to cut the sculpture and armature into multiple pieces upon completion.

A need exists for a pre-made armature, having a base structure, such as a skeletal system, already formed, using proportional rigid members having the shape of parts of an object to be sculpted. Use of pre-existing rigid members that are proportional to one another eliminates the possibility of mistakes relating to proportion when constructing an armature, while conserving the time and labor required to construct the armature.

A further need exists for an armature that is movable, having connecting members that are flexible and/or easily adjustable, enabling foam or other rigid members to be quickly and simply positioned and moved, as needed, without requiring laborious modifications to the armature, and without significantly interfering with the sculpting materials or process.

A need also exists for an armature that can be easily separated once assembled, both before and after placing and sculpting clay on the rigid members, such separation being able to occur at connection points between rigid members, or in the middle of a rigid member by cutting through the foam or other material from which the rigid member is formed. Use of a separable armature facilitates transport, storage, and/or casting of a durable material, such as porcelain, bronze or another metal.

The present embodiments meet these needs.

### SUMMARY

The present embodiments include a movable armature for creating a sculpture, the movable armature having a plurality of rigid members. Each rigid member has a shape representing a part of an object, which can include a human or other animal, or other living or inanimate objects. For example, each rigid member can have the shape of a section of a human skeleton.

The rigid members can be formed from a polymer foam material, such as polyurethane. Urethane foam is more durable than conventional polystyrene, but remains soft and porous enough to be cut, shaped, or otherwise manipulated to provide detail, texture, or modifications to portions of the armature. Additionally, modeling clay adheres more readily to urethane foam than to polystyrene.

Each rigid member is pre-formed, such as through use of a mold, a digital cutting or laser process, or a similar shaping process, such that the rigid members are proportional in size in relation to each other. Use of pre-formed, proportional, rigid members eliminates the potential for mistakes relating to the proportionality of the armature, while conserving the time and labor required for a sculptor to create a customized armature for each sculpture to be undertaken. Further, use of a pre-formed armature can enable an untrained or lesser-trained sculptor to create aesthetic sculptures by avoiding mistakes relating to construction of the armature.

The movable armature also includes one or more movable members used for connecting adjacent rigid members. Each rigid member is adapted for attachment to at least one other rigid member, with at least one movable member therebetween. The movable members provide connected rigid members with a range of motion used to position the movable armature.

The movable members can include lengths of a bendable metal or plastic, a shapeable polymer, and/or other similar materials that are bendable while retaining and holding an orientation and supporting the weight of the finished sculpture. In an embodiment, one or more of the movable members can include a protruding member or a similar portion configured to engage or interlock with engagement members disposed within the rigid members. For example, one or more of the rigid members can include internal hooks, rings, and/or clasps through which a protruding portion of a movable member can be inserted to form a secure engagement.

In an embodiment, one or more connected rigid members and/or one or more movable members can include a locking member for controlling the range of motion between two connected rigid members. Use of a locking member can prevent the positioning of the movable armature in an undesirable, unaesthetic, or erroneous pose.

A locking member can be used to simulate the motion of a hinge joint, a ball-and-socket joint, or a similar joint in an armature representing a human skeleton. For example, a locking member can include one or more clasps or hooks disposed on a first rigid member, and a pin or protrusion disposed on a second rigid member for engaging the one or more clasps. The pin can engage the clasp such that the pin is rotatably movable within the clasp, allowing the second rigid member to be movable in a first direction in relation to the first rigid member, while movement perpendicular to the first direction is prevented, thereby simulating a hinge joint.

The movable armature can include a shapeable material, such as clay, putty, paper mache, plaster, polymer, resin, or another similar material able to be sculpted, disposed on the plurality of rigid members. The clay or similar material can then be sculpted to create detailed features of the sculpture. For example, an armature representing an animal skeleton can be covered with a thin layer of clay, and the clay can be sculpted to represent muscles, exterior textures, facial features, and other similar details unique to the sculpture.

A durable material can then be disposed on the shapeable material. Durable materials can include porcelain or another material usable for casting a sculpture of bronze or another metal. Other durable materials are also usable. Alternatively or additionally, the clay or other shapeable material used to create the sculpture can be hardened.

In an embodiment, the movable armature can also include a movable securing member engaged with one or more of the rigid members for securing the movable armature to a surface while providing the movable armature with a range of motion in relation to the surface. The movable securing member can include a back iron, one or more wires, a stand, or a similar apparatus connected to or configured for engaging a wall, floor, stand, or similar surface. The securing member can be made from polyvinyl chloride or other inexpensive, lightweight materials, in lieu of conventional metal, for reducing both the weight and the cost of the securing member.

For example, the movable securing member can include a ball-shaped portion, and one or more of the rigid members, such as the spine or pelvis of an armature representing a human, can have a socket for engaging the ball-shaped portion. A socket can also be disposed on one or more of the movable members. In an embodiment, a movable socket can be configured for attachment to any of the rigid or movable members of the armature. Engagement of the ball-shaped portion with the socket can provide the movable armature with a range of motion in relation to a surface with which the movable securing member is engaged, while preventing erroneous or unnatural positioning of the armature.

The present embodiments also relate to methods for creating a sculpture using a movable armature, as described previously.

The movable armature can be provided, having proportional rigid members connected using movable members. In an embodiment, the plurality of rigid members and the one or more movable members can be provided separately, and the present method can include assembling the movable armature by connecting each rigid member to at least one other rigid member, with at least one movable member therebetween.

The armature can be positioned in a desired position, such as by manually bending and/or adjusting the movable members, as described above. A shapeable material is then applied to the movable armature, where it is sculpted to form a sculpture. The shapeable material can be hardened, and/or the sculpture can be cast in a durable material.

In an embodiment, one or more of the rigid members can be cut, shaped, or otherwise modified prior to application of the shapeable material. For example, a rigid member representing a human limb can be cut to remove a portion when sculpting an amputee, or a rigid member representing a human skull and face can be modified to add a visible scar or other unique feature.

Following sculpting of the shapeable material, the sculpture can be partially or wholly separated into pieces by disassembling the armature, as described previously, to facilitate handling and transport.

In an embodiment, the movable armature can be engaged to a movable securing member, as described previously, and the movable armature can be positioned relative to a surface using the movable securing member.

The present movable armature and methods are thereby usable to create a proportional sculpture of an object quickly, while modifying the position of the armature efficiently and easily both before and during the sculpting process.

### BRIEF DESCRIPTION OF THE DRAWINGS

In the detailed description of the embodiments presented below, reference is made to the accompanying drawings, in which:

FIG. 1A, 1B; and 1C depict two rigid members of an embodiment of the present movable armature connected using a movable member.

FIG. 2 depicts an embodiment of a movable armature for sculpting a human or similar biped;

FIG. 3 depicts an embodiment of a movable securing member usable to secure the present movable armature to a surface;

FIG. 4 depicts an embodiment of a movable armature for sculpting a horse or similar quadruped.

The present embodiments are detailed below with reference to the listed Figures.

### DETAILED DESCRIPTION OF THE EMBODIMENTS

Before explaining the present embodiments in detail, it is to be understood that the embodiments are not limited to the particular descriptions and that the embodiments can be practiced or carried out in various ways.

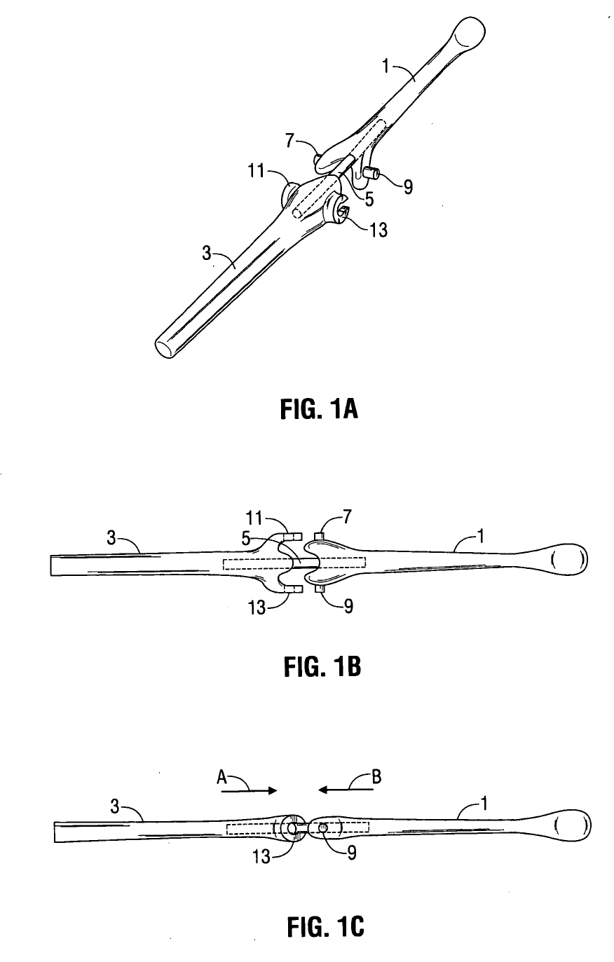

Referring now to FIGS. 1A, 1B, and 1C, a ¾ view, a top view, and a side view, respectively, of two rigid members connecting using a movable member are shown.

A first rigid member (1) and a second rigid member (3) are shown, each having a shape representing the structure of a human bone. The rigid members (1, 3) have dimensions that are proportional to one another, and to any other rigid members intended for use as part of the same movable armature. The rigid members (1, 3) can be made from foam, or from another sturdy material, including but not limited to plaster, plastic, one or more polymers, fiberglass, metal, or combinations thereof. Preferably, the rigid members (1, 3) are made from a sturdy material that can be readily cut, such as polyurethane foam, to enable modifications to the movable armature, if necessary.

A movable member (5) is shown disposed between and connecting the two rigid members (1, 3). FIGS. 1A, 1B, and 1C depict the movable member (5) as a bendable length of aluminum wire, however other ductile materials can also be used. Each rigid member (1, 3) can have an opening for receiving the movable member (5), or the movable member (5) can be used to physically penetrate into the rigid members (1, 3). For example, an aluminum wire could be axially pressed into rigid members made from polyurethane foam to penetrate a sufficient length into the foam to secure the wire.

The movable member (5) serves as a point of mobility, representing a joint between the connected rigid members (1, 3), allowing the rigid members (1, 3) to be moved with respect to one another.

The first rigid member (1) is shown having a first pin (7) and a second pin (9) protruding from the end proximate to the second rigid member (3). The second rigid member (3) is shown having a first hook (11) and a second hook (13), configured to engage the first pin (7) and second pin (9), respectively. When engaged, pins (7, 9) are rotatably movable within the hooks (11, 13) in a first direction, but restricted from movement perpendicular to the first direction. The hooks and pins thereby restrict the movement of the rigid members (1, 3) relative to each other, simulating a hinge joint. Other types of fasteners and/or locking members for connecting the rigid members (1, 3) are also usable, such as clasps or hinges.

The rigid members (1, 3) can lack pins, hooks, and similar locking members, or the locking members can be left disconnected, when it is desired to retain a full range of motion between the rigid members (1, 3), such as when simulating the motion of a ball and socket joint.

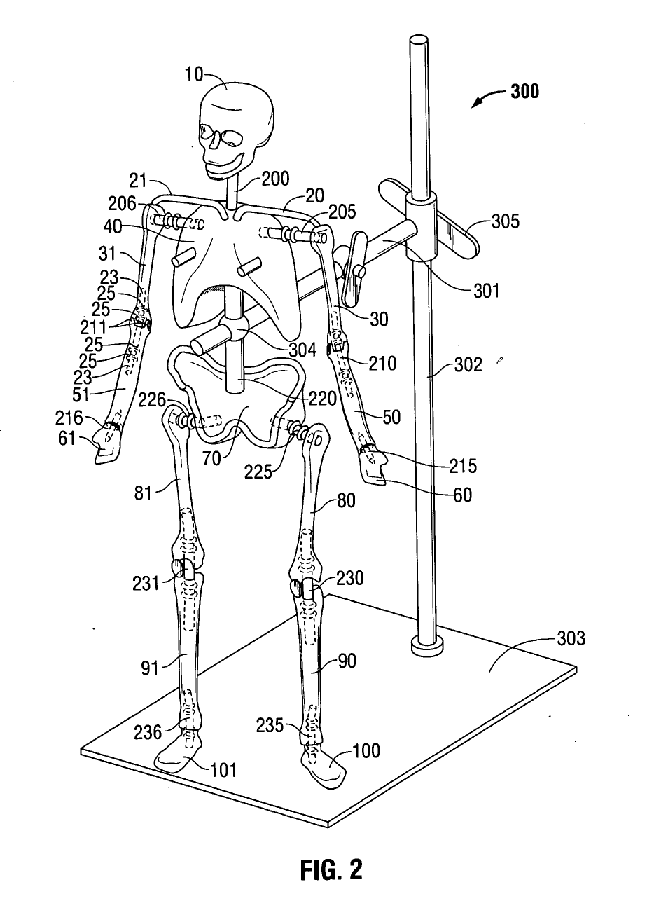

Referring now to FIG. 2, an embodiment of a movable armature for creating a sculpture of a human or similar biped is depicted. The armature is depicted having a plurality of rigid members, each having dimensions proportional to one another, and a plurality of movable members connecting adjacent rigid members.

A rigid member representing a skull (10) is shown connected to a rigid member representing a torso (40) by a movable member representing a neck (200). The skull (10) is shown having features representing eye sockets, a nose, a mouth, and ears, each of these features proportional in both size and location, enabling a face and head to be sculpted using the skull (10) without errors relating to proportionality. It should be noted that any of the depicted features of the skull (10) could be omitted, and that a rigid member representing a skull could have various additional features as well. For example, the skull (10) could be formed lacking ears, and ears could later be molded externally using clay or another shapeable material during the sculpting process.

The torso (40) is shown having a rigid member representing a left shoulder blade (20), and a rigid member representing a right shoulder blade (21) attached thereto. In an embodiment, the shoulder blades (20, 21) can be omitted. The torso (40) is further shown attached to rigid members representing a left upper arm (30) and a right upper arm (31) with a left shoulder movable member (205) and a right shoulder movable member (206), respectively. The left and right shoulder movable members (205, 206) are shown engaging the left and right upper arms (30, 31) perpendicularly, rather than axially, which provides the upper arms (30, 31) with 360 degrees of rotational movement with respect to the left and right shoulder movable members (205, 206) and the torso (40), simulating a ball-and-socket joint.

A movable member representing a left elbow (210) connects the left upper arm (30) to a rigid member representing a left lower arm (50). A movable member representing a right elbow (211) connects the right upper arm (31) to a rigid member representing a right lower arm (51). The left and right lower arms (50, 51) are shown having hooks which engage pins on the left and right upper arms (30, 31), in the manner depicted in FIGS. 1A, 1B, and 1C. The movement of the left and right elbows (210, 211) is restricted by this engagement, thereby simulating a hinge joint.

The movable member (211) is shown having protruding portions (23) at each end, which can be pressed through engagement members (25) disposed in the adjacent rigid members (31, 51), to form a secure engagement, thereby preventing the movable member (211) from becoming disengaged during movement of the movable armature. Other movable members can have similar securing elements.

A movable member representing a left wrist (215) connects the left lower arm (50) to a rigid member representing a left hand (60). A movable member representing a right wrist (216) connects the right lower arm (51) to a rigid member representing a right hand (61). The rigid members representing the hands (60, 61) can include protrusions representing fingers, or lack such protrusions. The left and right wrists (215, 216) are shown lacking engagements between adjacent rigid members to provide the hands (60, 61) with full pivotal and rotational movement with respect to the left and right lower arms (50, 51).

Both arm assemblies can be manipulated into a selected position by bending the flexible members, while the rigid members provide inflexible support to represent the object to be sculpted.

FIG. 2 further depicts a flexible member representing a spine (220) connecting the torso (40) to a rigid member representing a pelvis (70). The spine (220) includes a socket (304) for connection to a movable support member (300). In an embodiment, the socket (304) could be disposed in the pelvis (70) or in another part of the movable armature.

The movable support member (300) is shown having a vertical support member (302) connected to a base (303) on which the movable armature is positioned. A horizontal support member (301) is shown connected to the vertical support member (302) at a height approximately equal to that of the socket (304). The horizontal support member (301) can have a threaded portion, which protrudes through an opening in the vertical support member (302), where the horizontal support member (301) can engage an adjustable nut (305) or similar device for securing the horizontal support member (301) to the vertical support member (302).

The horizontal support member (301), vertical support member (302), adjustable nut (305), or combinations thereof, can be made from any sturdy material, including metal, wire, polyvinyl chloride, plastic, a polymer, or other similar materials. Use of polyvinyl chloride can be beneficial for reducing the weight and cost of the movable support member (300).

The engagement of the movable support member (300) with the socket (304) provides the movable armature with a range of motion relative to the base (303), enabling movement and positioning of the movable armature in its entirety, in addition to movement of individual parts of the armature.

The pelvis (70) is shown having movable members representing a left hip flexor (225) and a right hip flexor (226) attached thereto. A rigid member representing a left upper leg (80) is attached to the left hip flexor (225). A rigid member representing a right upper leg (81) is attached to the right hip flexor (226). The connections between the upper legs (80, 81) and the pelvis (70) via the hip flexors (225, 226) provides a range of motion between the upper legs (80, 81) and the pelvis (70) that simulates a ball-and-socket joint.

A rigid member representing a left lower leg (90) is shown connected to the left upper leg (80) using a movable member representing a left knee (230). A rigid member representing a right lower leg (91) is shown connected to the right upper leg (81) using a movable member representing a right knee (231). The rigid members representing the upper and lower legs (80, 81, 90, 91) are shown having clasps and protrusions similar to those used to engage the rigid members representing the upper and lower arms (30, 31, 50, 51) with one another, enabling the right and left knees (230, 231) to simulate the motion of hinge joints.

A rigid member representing a left foot (100) is shown connected to the left lower leg (90) using a movable member representing a left ankle (235). A rigid member representing a right foot (101) is shown connected to the right lower leg (91) using a movable member representing a right ankle (236). The rigid members representing the feet (100, 101) can include protrusions representing toes, or lack such protrusions. The left and right ankles (235, 236) are shown lacking engagements between adjacent rigid members to provide the feet (100, 101) with a large range of pivotal and rotational movement with respect to the left and right lower legs (90, 91).

The feet (100, 101) are shown resting against the base (303). The contact between the feet (100, 101) and the base (303), coupled with the engagement between the socket (304) and the movable support member (300), can enable the movable armature to be positioned in a variety of poses with respect to the base (303).

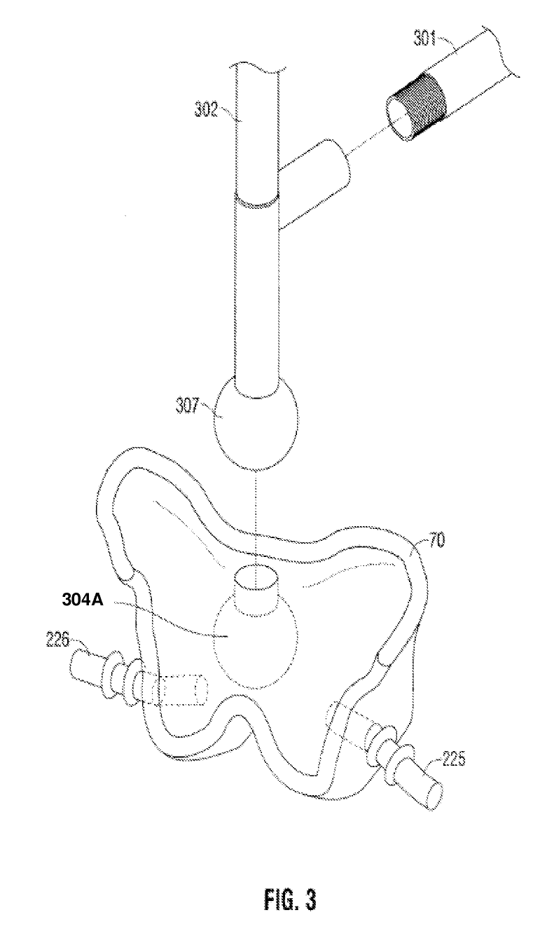

Referring now to FIG. 3, an alternate embodiment of a movable support member usable to secure the movable armature to a base, wall, or similar structure, is depicted.

A rigid member representing a pelvis (70) is shown, having movable members representing hip flexors (225, 226) attached thereto. The pelvis (70) has a ball-shaped socket (304) for engaging a ball-shaped portion (307) of a movable support member.

The movable support member is shown having a horizontal support (301), which is shown as a backiron formed from polyvinyl chloride, configured for threaded engagement with a vertical support (302), which is depicted as an almaloy wire having the ball-shaped portion (307) attached thereon.

Engagement between the ball-shaped portion (307) and the ball-shaped socket (304) provides the movable armature with a range of motion relative to the surfaces to which the horizontal and vertical supports (301, 302) are secured.

Other configurations for the depicted movable support member are also possible. For example, the ball-shaped portion (307) could be attached to the horizontal support member (301), rather than the vertical support member (302). Alternatively, the ball-shaped portion could be disposed on the movable armature for engagement with a socket disposed on the movable support member. Further, a movable socket could be used, which is configured for attachment to any of the rigid members or movable members of the present movable armature, or built-in sockets or ball-shaped portions could be disposed on any portion of the movable armature, as needed to connect with the movable securing member.

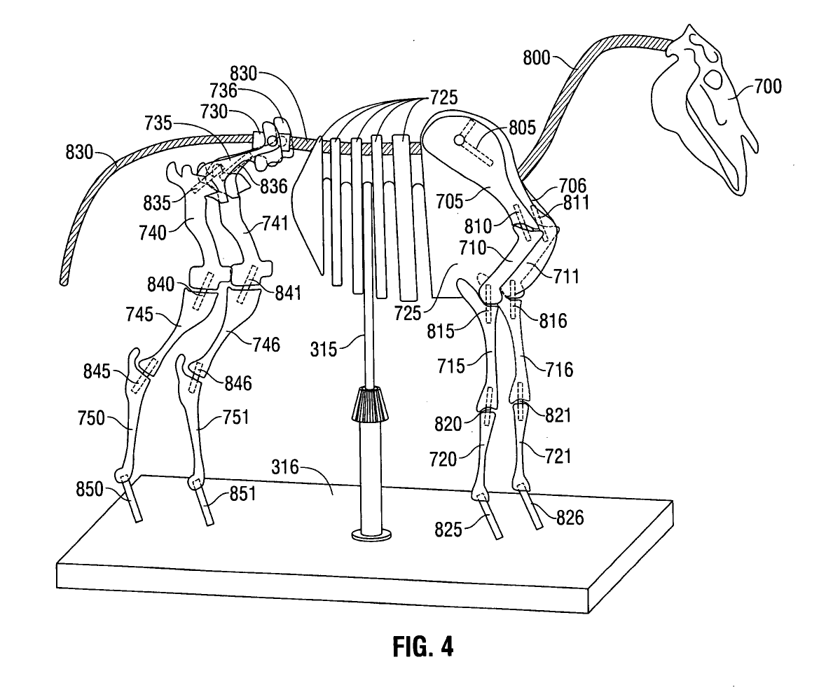

Referring now to FIG. 4, an embodiment of the present movable armature usable to create a sculpture of a horse or similar quadruped is shown.

A movable member representing a neck (800) is shown connecting a rigid member representing a skull (700) to a rigid member representing a rib cage (725), having a plurality of protrusions representing ribs. While FIG. 4 depicts a single rigid member having the basic shape of the rib cage (725), a combination of individual rigid members representing one or more ribs or portions of the rib cage could be used.

A right front leg assembly is shown, formed by connecting a first front right leg member (705) to the rib cage (725) using a movable member (805). A second front right leg member (710) is connected to the first front right leg member (705) using a movable member (810). A third front right leg member (715) is connected to the second front right leg member (710) using a movable member (815). A fourth front right leg member (720) is shown connected to the third front right leg member (715) using a movable member (820). A movable member (825) is shown connected to the fourth front right leg member (720) for attachment to a foot, a base, or another rigid member, securing member, or stand or similar member for providing stability to the movable armature. Usable rigid members can represent feet, claws, hands, hooves, or other similar appendages.

A left front leg assembly is shown, having an assembly similar to that of the right front leg assembly. A first left front leg member (706) is connected to the rib cage (725) using a movable member (not visible in FIG. 4). A second left front leg member (711) is connected to the first left front leg member (706) using a movable member (811). A third left front leg member (716) is shown connected to the second left front leg member (711) using a movable member (816). A fourth left front leg member (721) is shown connected to the third left front leg member (716) using a movable member (821). A movable member (826) is shown connected to the fourth front left leg member (721) for attachment to a foot, a base, or another rigid member, securing member, or stand or similar member for providing stability to the movable armature.

Both front leg assemblies can be manipulated into a selected pose by bending along the movable members, while inflexible support is provided by the rigid members. The rigid members and flexible members are proportional with respect to one another and with respect to the overall dimensions of the movable armature. The rigid members can include locking members for restricting their range of motion relative to one another, as described previously.

A movable support member (315) is shown connecting the rib cage (725) to a base (316) on which the movable armature can be positioned. The movable support member (315) provides the movable armature with a range of motion relative to the base (316). The movable support member (315) can be adjustable to control the distance between the movable armature and the base (316).

A lower movable member representing a spine and tail (830) connects the rib cage (725) to a rigid member representing a spine insert and pelvis (730), which is attached to rigid members representing upper portions of the left and right rear legs (735, 736).

A movable member (835) is shown connecting the upper right rear leg (735) to a second upper right rear leg portion (740). A third upper right rear leg portion (745) is connected to the second upper right rear leg portion (740) using a movable member (840). A fourth upper right rear leg portion (750) is shown connected to the third upper right rear leg portion (745) using a movable member (845). A movable member (850) is attached to the fourth upper right rear leg portion (750) for attachment to a foot, a base, or another rigid member, securing member, or stand or similar member for providing stability to the movable armature.

A second upper left rear leg portion (741) is attached to the upper portion of the left rear leg (736) using a movable member (836). A third upper left rear leg portion (746) is attached to the second upper left rear leg portion (741) using a movable member (841). A fourth upper left rear leg portion (751) is attached to the third upper left rear leg portion (746) using a movable member (846). A movable member (851) is attached to the fourth upper left rear leg portion (751) for attachment to a foot, a base, or another rigid member, securing member, or stand or similar member for providing stability to the movable armature.

The present movable armature is thereby able to simulate a proportional basic structure using pre-formed rigid members representing portions of an object that are proportional to one another, on which clay or another shapeable material can be placed to create an aesthetic and proportional sculpture. The armature further utilizes movable members to provide a realistic range of motion between adjacent rigid members, which can be restricted in motion to simulate an appropriate joint, thereby ensuring the realism of the position and pose of the finished sculpture.

While these embodiments have been described with emphasis on the embodiments, it should be understood that within the scope of the appended claims, the embodiments might be practiced other than as specifically described herein.

1. A movable armature for creating a sculpture, the movable armature comprising:
a plurality of rigid members, wherein each rigid member of the plurality of rigid members comprises a shape representing a part of an object, and wherein each rigid member of the plurality of rigid members is proportional in size to each other rigid member of the plurality of rigid members; and
at least one movable member for connecting adjacent rigid members, wherein each rigid member of the plurality of rigid members is adapted for attachment to at least one other rigid member of the plurality of rigid members with at least one movable member therebetween to form at least one pair of connected rigid members, wherein the at least one pair of connected rigid members provides a range of motion for positioning the movable armature, and wherein the at least one pair of connected rigid members is independently movable from each other of the rigid members of the movable armature.

2. The movable armature of claim 1, wherein at least one of: the at least one pair of connected rigid members, the at least one movable member, and combinations thereof, comprise a locking member for controlling the range of motion between the at least one pair of connected rigid members.

3. The movable armature of claim 2, wherein the locking member comprises at least one clasp disposed on a first rigid member and at least one pin disposed on a second rigid member for engaging said at least one clasp, wherein the pin is rotatably movable within the clasp in a first direction, and wherein the clasp restricts movement of the pin in a second direction perpendicular to the first direction.

4. The movable armature of claim 1, wherein said at least one movable member comprises a protruding member configured for engagement with at least one engagement member disposed within at least one rigid member of the plurality of rigid members.

5. The movable armature of claim 1, wherein at least one of the rigid members is formed from at least one of: polymer foam material, plastic, plaster, metal, and combinations thereof.

6. The movable armature of claim 1, wherein said at least one movable member is formed from at least one of: bendable metal, plastic, shapeable polymer, and combinations thereof.

7. The movable armature of claim 1, further comprising a shapeable material disposed on the plurality of rigid members for sculpting detailed features of the object.

8. The movable armature of claim 1, further comprising a movable securing member engaged with the movable armature for securing the movable armature to a surface while enabling positioning of the movable armature in relation to the surface.

9. The movable armature of claim 8, wherein the movable securing member comprises a ball-shaped portion, wherein said at least one of the rigid members comprises a socket for engaging the ball-shaped portion, and wherein engagement of the ball-shaped portion with the socket provides the movable armature with a range of motion in relation to the surface.

10. (canceled)

11. The movable armature of claim 1, wherein the object is an animal.

12. The movable armature of claim 7, further comprising a durable material disposed on the shapeable material.

13. A method for creating a sculpture, the method comprising the steps of:
providing a plurality of rigid members, wherein each rigid member of the plurality of rigid members comprises a shape representing a part of an object, and wherein each rigid member of the plurality of rigid members is proportional in size to each other rigid member of the plurality of rigid members;
providing at least one movable member for connecting adjacent rigid members;
assembling a movable armature by connecting each rigid member of the plurality of rigid members to at least one other rigid member of the plurality of rigid members with said at least one movable member therebetween, wherein said at least one movable member provides at least two connected rigid members with a range of motion for positioning the movable armature;
positioning the movable armature in a desired position;
applying a shapeable material to the movable armature and sculpting the shapeable material to form a sculpture.

14. The method of claim 13, further comprising the step of separating at least a portion of the sculpture into multiple pieces by at least partially disassembling the movable armature for facilitating handling and transport of the sculpture.

15. The method of claim 13, further comprising the steps of engaging the movable armature to a movable securing member engaged with a surface and positioning the movable armature in relation to the surface using the movable securing member.

16. The method of claim 13, further comprising the steps of hardening the shapeable material, casting the sculpture in a durable material, or combinations thereof.

17. The method of claim 13, wherein said at least one movable member comprises a protruding member configured for engagement with at least one engagement member disposed within at least one rigid member of the plurality of rigid members, and wherein the method further comprises the step of engaging the protruding member with said at least one engagement member.

18. The method of claim 13, further comprising the step of shaping at least one of the rigid members of the plurality of rigid members for providing visible modifications to the sculpture.

19. A method for creating a sculpture, the method comprising the steps of:
providing a movable armature comprising a plurality of rigid members connected together in the shape of an object using at least one movable member connecting adjacent rigid members, wherein each rigid member of the plurality of rigid members comprises a shape representing a part of the object, and wherein each rigid member of the plurality of rigid members is proportional in size to each other rigid member of the plurality of rigid members;
positioning the movable armature in a desired position;
applying a shapeable material to the movable armature and sculpting the shapeable material to form a sculpture.

20. The method of claim 19, further comprising the step of assembling the movable armature by connecting each rigid member of the plurality of rigid members to at least one other rigid member of the plurality of rigid members with said at least one movable member therebetween, wherein said at least one movable member provides at least two connected rigid members with a range of motion for positioning the movable armature.

21. The method of claim 19, further comprising the step of separating at least a portion of the sculpture into multiple pieces by at least partially disassembling the movable armature for facilitating handling and transport of the sculpture.

22. The method of claim 19, further comprising the steps of engaging the movable armature to a movable securing member engaged with a surface and positioning the movable armature in relation to the surface using the movable securing member.

23. The method of claim 19, further comprising the steps of hardening the shapeable material, casting the sculpture in a durable material, or combinations thereof.

24. The method of claim 19, wherein said at least one movable member comprises a protruding member configured for engagement with at least one engagement member disposed within at least one rigid member of the plurality of rigid members, and wherein the method further comprises the step of engaging the protruding member with said at least one engagement member.

25. The method of claim 19, further comprising the step of shaping at least one of the rigid members of the plurality of rigid members for providing visible modifications to the sculpture.

26. The movable armature of claim 1, wherein each of the plurality of rigid members are configured for easy separation before and after a shapeable material is disposed thereon.

27. The movable armature of claim 1, wherein the at least two connected rigid members are pre-formed to be proportional in size with each other.

28. The movable armature of claim 7, wherein the shapeable material comprises clay.

29. The movable armature of claim 28, wherein the clay is hardened.

30. The movable armature of claim 1, wherein the object is an inanimate object.

31. The movable armature of claim 1, wherein each one of the plurality of rigid members is connected to at least one other rigid member, and wherein each of the rigid members is independently movable.
